(19) United States
(12) Patent Application Publication
(10) Pub. No.: US 2010/0014547 A1
(43) Pub. Date: Jan. 21, 2010

(54) Device For Longitudinal Pumping Of A Laser Medium

(75) Inventor: Louis Cabaret, Plessis-Saint-Benoist (FR)

Correspondence Address: HARNESS, DICKEY & PIERCE, P.L.C., P.O. BOX 828, BLOOMFIELD HILLS, MI, 48303, US

(73) Assignee: CENTRE NATIONAL DE LA RECHERCHE SCIENTIFIQUE- CNRS, Paris Cedex 16 (FR)

(21) Appl. No.: 12/223,229

(22) PCT Filed: Jan. 25, 2007
(86) PCT No.: PCT/FR2007/000143

§ 371 Date: Sep. 8, 2009

(30) Foreign Application Priority Data
Jan. 31, 2006 (FR) 0650339

(51) Int. Cl. H01S 3/042; H01S 3/0941; H01S 3/07

(52) U.S. Cl. 372/34; 372/75; 372/66; 372/66

(57) ABSTRACT

The invention concerns a device for longitudinal pumping of an amplifying laser medium comprising at least one laser diode capable of emitting at least one laser beam, means for focusing said laser beam onto said amplifying laser medium and means for collimating said laser beam capable of generating a collimated laser beam. The invention is characterized in that said focusing means comprise at least one mirror, said mirror being arranged such that said collimated beam is reflected towards the amplifying medium.

### CROSS-REFERENCE TO RELATED APPLICATIONS

This application is a National Phase Entry of International Application No. PCT/FR2007/000143, filed Jan. 25, 2007, claiming priority to French Patent Application No. 06/50339, filed Jan. 31, 2006, both of which are incorporated by reference herein.

### BACKGROUND AND SUMMARY

The present invention relates to the field of devices for longitudinal pumping of an amplifying laser medium. It relates more particularly to a device for longitudinal pumping of an amplifying laser medium comprising at least one laser diode capable of emitting at least one laser beam, means for collimating said laser beam, and means for focussing said collimated laser beam onto said amplifying laser medium.

Such devices are known, for example, from German patent application DE 10235713 relating to a device comprising a plurality of laser diodes each emitting a laser beam. These diodes are axially positioned around the direction of propagation of the laser beam, and emit radiation collimated by an array of lenses that direct the beam towards a laser medium with a relatively low angle in relation to the direction of propagation of the laser beam. However, it is understood that in order to perform high-energy longitudinal pumping, and thus to have a large number of laser diodes emitting a large number of laser beams with a low angle of incidence, the arrangement described in the aforementioned German patent application is inefficient due to the plurality of diodes and the need to be focussed by an array of lenses.

A first aim of the present invention is therefore to provide a longitudinal pumping device with improved compactness. Another aim of the present invention is to provide a longitudinal pumping device which can operate with high energy levels. Another aim of the present invention is to provide a longitudinal pumping device which can operate in the presence of a large number of pumping laser diodes. Another aim of the present invention is to provide a longitudinal pumping device for which the pumped zone is separated from the contours of the pumped rod so as to avoid the effects of diffraction. Another aim of the present invention is to allow substantially uniform pumping of the amplifying laser medium.

At least one of the above aims is achieved according to the invention by a device for longitudinal pumping of an amplifying laser medium comprising at least one laser diode capable of emitting at least one laser beam, means for collimating said laser beam capable of generating a collimated laser beam, means for focussing said collimated laser beam onto said amplifying laser medium, characterised in that said focussing means comprise at least one mirror, said mirror being arranged such that said collimated beam is reflected towards said amplifying medium. In order to adapt to the laser rod configurations in which said laser medium is a cylinder, the axis of rotation of said cylinder is positioned according to a longitudinal emission axis of said laser medium and said device comprises a plurality of diodes surrounding said laser medium. Thus, the device according to the invention is compact since the mirrors allow the beams to be reflected towards to the amplifying medium.

In order to use the standard diode configurations, and thus to reduce the cost of producing the invention, said plurality of diodes is formed by a plurality of diode arrays positioned according to a longitudinal emission axis of said amplifying medium, said device comprising a plurality of mirrors, each one of said mirrors being associated with one of said arrays. The specific association of each mirror with each diode array with which it is associated by the beam makes it possible to adjust the pumped volume. In order to minimise the pumped volume, said arrays are spaced out angularly around said amplifying medium, each one of said arrays defining an angle formed by the axis defined by the straight line between said array and the centre of said mirror associated with said array and the emission axis of said laser medium, said mirror being tilted in relation to the straight line connecting said array and the centre of said mirror associated with said array and the emission axis of said laser medium according to said angle.

When the device comprises means for cooling said compensating medium, said cooling means being positioned between said at least one diode and said amplifying medium, a non-doped material is preferably positioned between said at least one mirror and said amplifying medium in the trajectory of said reflected beam. This reduces the power of the thermal lens created by said cooling means. For low-energy pumping systems, said device comprises a first laser diode capable of emitting a first laser beam, and a second laser diode capable of emitting a second laser beam, said device comprising a first mirror associated with said first diode and a second mirror associated with said second diode, said amplifying medium comprising a first longitudinal surface and a second longitudinal surface, said first mirror being arranged so as to reflect said first laser beam towards said first surface of said amplifying medium, said second mirror being arranged so as to reflect said second laser beam towards said second surface of said amplifying medium. In order to obtain uniform lighting of said amplifying medium, said at least one mirror is a parabolic mirror.

### BRIEF DESCRIPTION OF DRAWINGS

The invention will be better understood with the help of the appended figures, wherein:

FIG. 1 shows a longitudinal pumping device according to a first embodiment of the invention;

FIG. 2 shows a longitudinal pumping device according to a second embodiment of the invention;

FIG. 3 shows the use of a non-doped part between the mirror and the amplifying medium according to the present invention;

FIG. 4 shows a longitudinal pumping device adapted for low energy levels;

FIG. 5 shows a longitudinal pumping device adapted for medium energy levels; and

FIG. 6 is a top view of FIG. 5.

### DETAILED DESCRIPTION

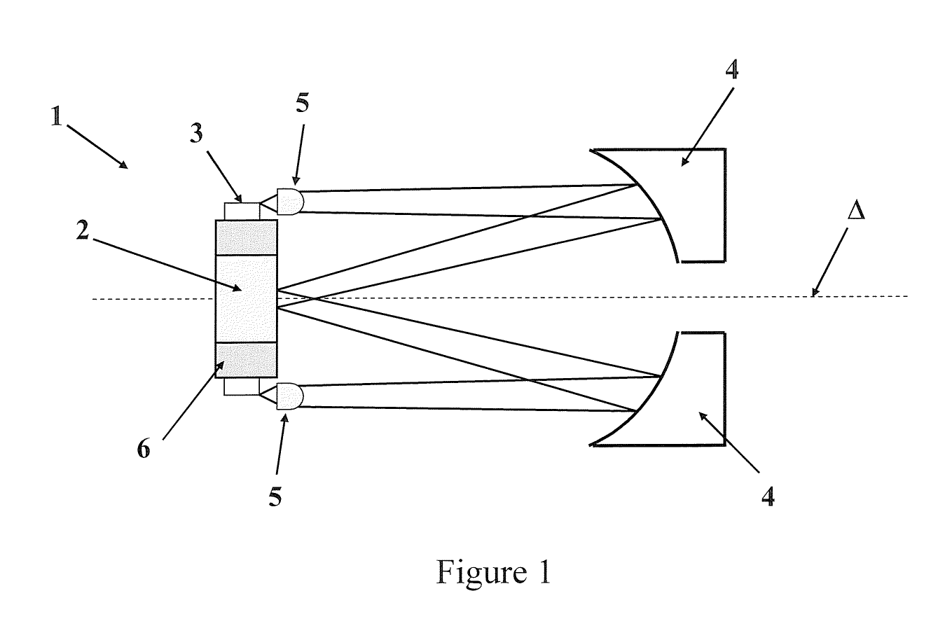

For the purpose of the present application, the term “longitudinal pumping” will be used to refer to a pumping mode in which a pumping beam (or a plurality of beams) is inserted in the amplifying medium by the same optical surfaces as the input or output surfaces of the amplified laser beam. According to a first embodiment of the invention shown in FIG. 1, a longitudinal pumping device 1 according to the invention comprises a laser amplifying medium 2 in the form of a laser rod, an array of diodes 3, and one or more folding mirrors 4. It also comprises means for collimating the beam emitted by the diodes, for example in the form of an assembly of lenses 5. It also comprises a device 6 for cooling the diodes 3 and the rod 2, for example positioned between the diodes 3 and the rod 2.

The arrays of laser diodes 3 form a crown that surrounds the cylindrical solid-state amplifying medium 2, the axis of rotation of the cylinder matching the direction of emission of the laser beam Δ. The beams emitted by the arrays 3 are collimated by the assembly of mirrors 5 and returned by a concave mirror 4. The concave mirror is then arranged to focus the beams on one of the ends of the laser rod 2. The multiple collimated beams emitted from the diodes are superimposed at the end of the laser rod to form a substantially uniform stain with higher intensity at the centre.

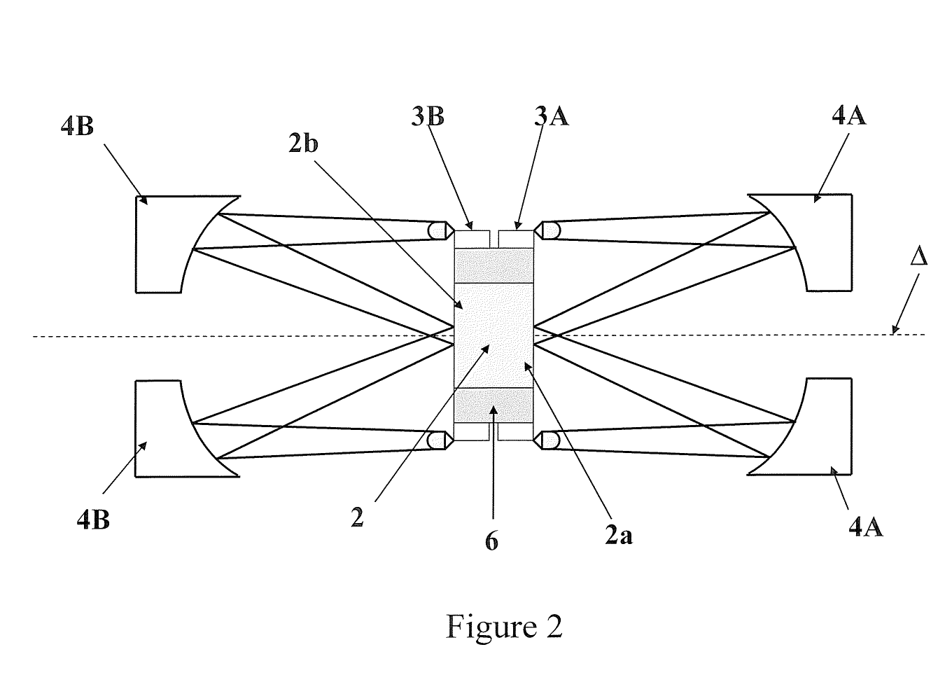

According to the invention it is also possible to light the laser rod 2 at both its ends. This is shown in FIG. 2 according to a second embodiment of the invention in which a laser rod 2 is provided, comprising a first end 2a and a second end 2b, a first crown of diode arrays 3A and a second crown of diode arrays 3B. These two crowns surround the rod 2. The first crown 3A emits a collimated light beam towards a first mirror 4A on the side of the end 2a. This beam is then reflected towards the first end 2a. In the same way, a light beam emitted by the arrays 3B is reflected by a mirror 4B towards the end 2b. In this configuration it is possible, at the same time, to adapt the cross-section of the pumped zone and the diameter of the pump beam to be amplified to optimise the optical output ratio.

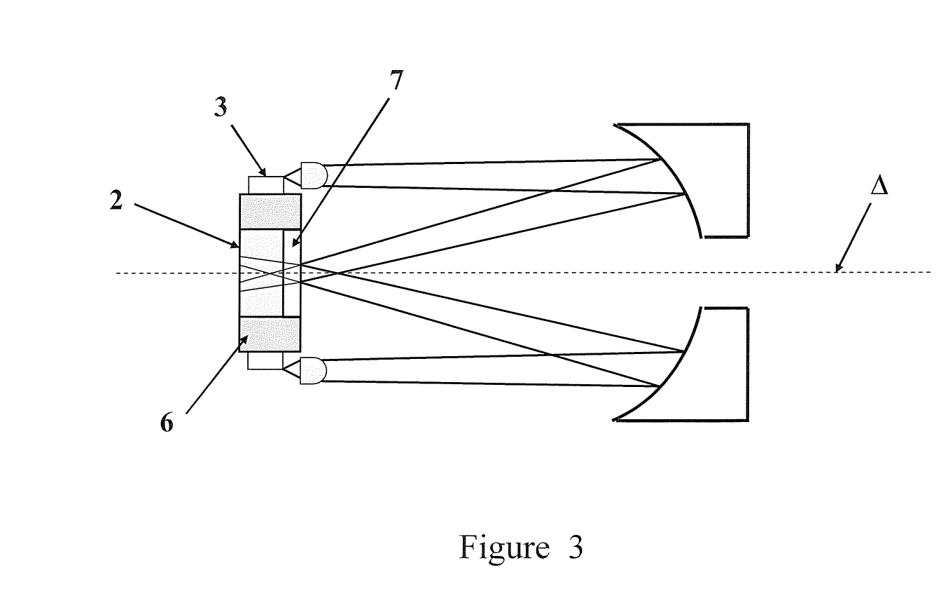

If the cylindrical rod 2 is cooled at its periphery, for example by a cooling device 6, a thermal lens is created rotating around the axis of rotation of the system. One method of reducing the power of the thermal lens consists of cooling the rod by its ends so as to give the thermal gradient a longitudinal component. To do so, as shown in FIG. 3, non-doped rod ends 7 which are therefore not thermally loaded are welded to at one end of the rod, allowing the rod to be efficiently cooled at the point with the greatest thermal deposit. In this way, the optical distortions caused by the thermal deposits in the amplifying medium 2 are kept at a relatively low level.

In configurations in which the arrays of diodes 3 are arranged in a crown around an amplifying rod 2, as in FIGS. 1, 2 and 3, it is easy to produce high-energy devices by increasing the number of diodes in the crown and thus the diameter of the crown. The arrangement of the mirror is then adjusted, increasing the focal distance of the mirror and the distance between the diodes 3 and the mirror 4.

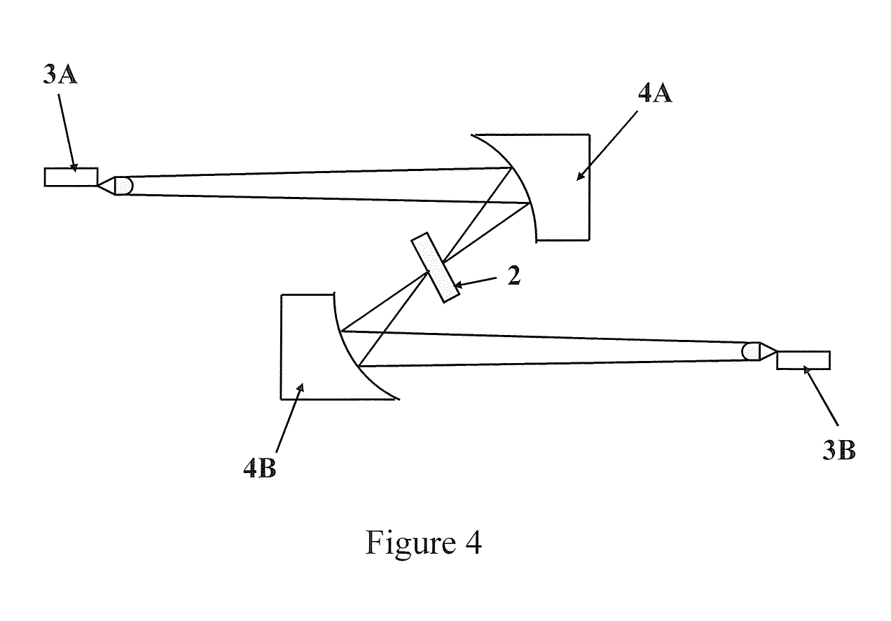

For low-energy pumping devices, which therefore have a small number of diodes, an arrangement such as shown in FIG. 4 can be used, in which an array 3A or a stack of a small number of diode arrays emits a collimated beam towards a mirror 4A. The mirror 4A then reflects the beam towards the laser medium 2. A second array 3B is positioned substantially symmetrically to the first array in relation to the focal point of the first beam. A second mirror 4B is also installed to reflect the collimated beams emitted by the second array 3B towards the medium 2. The gain volume thus created is adequate for amplifying a laser beam with a diameter of 1 mm in a doped YAG plate.

In the various embodiments of the invention mentioned above, the configuration is dimensioned based on certain known parameters such as, for example, the cross-section of the pumped volume, for example defined by its diameter d, assessed according to the output energy and the characteristics of the laser material used, and the energy contained in the pumping pulse or the pumping power. From this latter energy it is possible to deduce the number N of laser rods required. To make the pumping head compact, the diameter D of the crown of diode arrays 3 is adjusted to that the arrays are right next to one another.

In order to obtain focussed, substantially uniform beams at the level of the laser rod 2, the mirror 4, 4A, 4B preferably has a parabolic shape with a focal distance f. It should be noted that the diode 3 is collimated according to a single axis, the so-called “rapid” axis, by means of a cylindrical lens. In the first order, the mirror 4 therefore forms two images of the diode. The first image is the image of the junction collimated by the cylindrical lens and located in the main focus of the mirror 4, and the second image is the direct image of the array on the mirror. At the location of the second image of the array, the beam is at its smallest size, and this is the size that must be matched with the diameter d of the pumped volume. And yet, this image is not aligned with the mirror and the images provided by the various arrays of the crown are therefore not combined.

In order to obtain the smallest pumped volume possible, it is therefore possible, according to one embodiment, to combine these images on the axis. To do so, the mirror 4 can be split into a plurality of identical sub-mirrors according to the number of diode arrays 3. The axis of each mirror is then tilted in relation to the axis of the system by an angle a if 2a is the angle subtended by the axis {array—centre of the mirror} and the axis of the system Δ. The formula used to calculate the angle α by approximation is: α=1/2*Arctan[D/(2*(x+f))], where x is the distance along the axis from the array to the focus of the mirror, D is the diameter of the crown of arrays and f is the focal distance of the mirror.

The following is an example of dimensioning on the one hand by pumping a low-energy Yb:YAG crystal in almost-continuous mode and, on the other hand, by pumping an Nd:YAG crystal with an energy level of the order of 100 mJ. For example, a Yb:YAG plate is pumped according to the configuration of FIG. 4 so as to pump a volume with a cross-section of around 1 mm on 1.8 mm corresponding to a laser beam with a diameter of 1 mm which circulates with Brewster incidence in the plate. According to this configuration, as the two focussing systems can be adjusted independently, there is no angle condition as previously mentioned. For the mirror dimensions to be reasonable, a focal distance of 15 mm is chosen, the pumping laser arrays having a standard length of 10 mm. To obtain a pumped volume length of 1.8 mm, a mirror enlargement of 0.18 is therefore required. The Newton formula providing the enlargement g=f/x, if x is the distance according to the axis from the array to the focus of the mirror, therefore gives a distance x of 83 mm. The direct image of the array is then located at a distance x′=f²/x from the focal plane, or 2.7 mm.

The previously defined diode has a total divergence of 10° with the slow axis of the diode, which is to say the non-collimated axis. The mirror must therefore have a diameter of at least 34 mm in order to intercept the entire beam. A metal mirror with this diameter is completely feasible with diamond machining.

In addition, with two stacks of three diodes 3A and 3B as in FIG. 4, the desired power can be achieved. Since the separation between the diodes is 1.4 mm, the images of the diodes in the plate will be separated by 0.25 mm. By adjusting the mirrors so that the images are in staggered rows, it is possible substantially to occupy the desired section considering the thickness of the images in the plane.

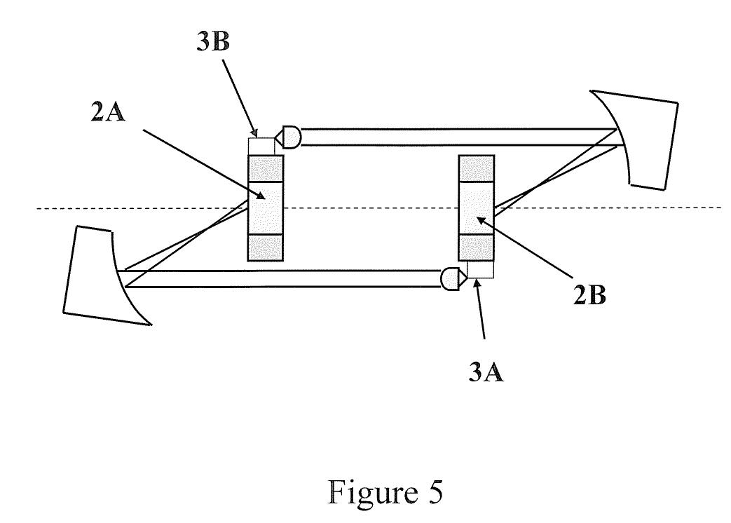

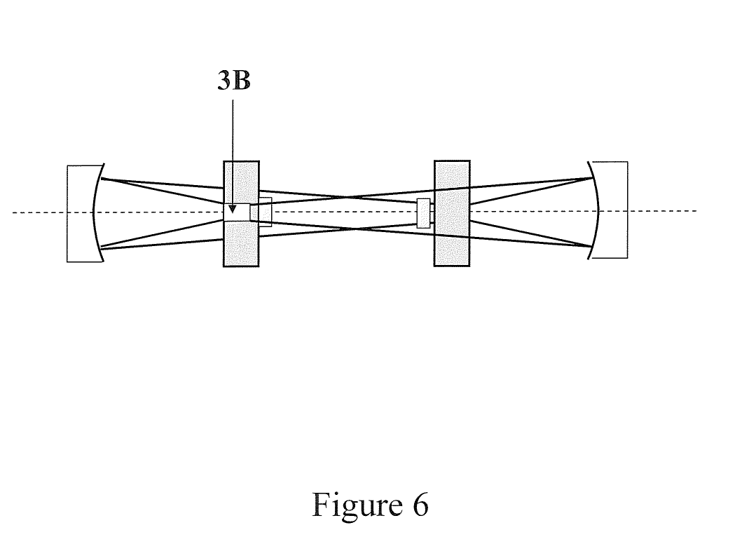

The following describes a medium-energy configuration in reference to FIGS. 5 and 6. For an energy level of the order of 100 mJ, forty arrays of laser diodes 3 are used, for example. These forty arrays are distributed in eight stacks of five arrays arranged end to end and pumping two rods 2A and 2B, which has the advantage of distributing the thermal load. Four sub-mirrors are arranged on each side of the device, only two of which are shown in FIG. 5. The diagonal dimension of the stack determines the pumped diameter. With the arrays spaced by 1.2 mm, a mirror enlargement of 0.36 is therefore required. With a parabolic mirror with a focal distance of 30 mm, the distance x from the array to the focus of the mirror is 83 mm and the distance x′ from the second image to the focal plane is 11 mm. The angle of inclination α of a sub-mirror in relation to the axis of the system is approximately 5° for a crown diameter of 40 mm. The diameter of the crown is calculated so that the trace of the beams is entirely contained within each sub-mirror.

1. A device for longitudinal pumping of an amplifying laser medium comprising:
at least one laser diode formed by at least one array of diodes, capable of emitting at least one laser beam;
a collimater operably generating a collimated laser beam; and
at least one mirror operably focussing said laser beam onto said amplifying laser medium, said mirror being arranged such that said collimated beam is reflected towards the amplifying medium;
said mirror being split into a plurality of identical sub-mirrors each associated with said array of diodes.

2. The device according to claim 1, wherein said diode comprises a plurality of arrays and in that each one of said sub-mirrors of said plurality of identical sub-mirrors cooperates with an array of said plurality of arrays.

3. The device according to claim 1, wherein each one of said sub-mirrors is tilted in relation to the axis of emission by an angle α if the angle formed by the axis defined by the straight line between said array and the centre of said mirror and the axis of emission is 2α.

4. The device according to claim 1, wherein each one of said sub-mirrors is arranged so as to receive a laser beam coming from an array of said plurality of arrays.

5. The device according to claim 1, wherein said laser medium is a cylinder, the axis of rotation of said cylinder being positioned according to an axis of emission of said laser medium, wherein said device comprises a plurality of diodes surrounding said laser medium.

6. The device according to claim 2, wherein said array of diodes is directed according to said axis of emission of said amplifying medium, said device comprising a plurality of mirrors, each one of said mirrors being associated with one of said arrays.

7. The device according to claim 3, wherein said arrays are spaced out angularly around said amplifying medium, each one of said arrays defining an angle formed by the axis defined by the straight line between said array and the centre of said mirror associated with said array and the axis of emission of said laser medium, said mirror being tilted in relation to the straight line passing through said array and the centre of said mirror associated with said array and the axis of emission of said laser medium according to said angle.

8. The device according to claim 1, also comprising a cooler operably cooling said amplifying medium, said cooler being positioned between said at least one diode and said amplifying medium, said device comprising a non-doped material positioned between said at least one mirror and said amplifying medium in the trajectory of said reflected beam.

9. The device according to claim 1, wherein said amplifying medium comprises at least one longitudinal surface, said mirror being arranged so that said collimated beam is reflected towards said longitudinal surface of said amplifying medium.

10. The device according to claim 1, wherein said device comprises a first laser diode capable of emitting a first laser beam, and a second laser diode capable of emitting a second laser beam, said device comprising a first mirror associated with said first diode and a second mirror associated with said second diode, said amplifying medium comprising a first longitudinal surface and a second longitudinal surface, said first mirror being arranged such as to reflect said first laser beam towards said first surface of said amplifying medium, said second mirror being arranged such as to reflect said second laser beam towards said second surface of said amplifying medium.

11. The device according to claim 1, wherein said at least one mirror is a parabolic mirror.
